(19) United States
(12) Patent Application Publication
(10) Pub. No.: US 2007/0272090 A1
(43) Pub. Date: Nov. 29, 2007

(54) Hydrogen mitigation and energy generation with water-activated chemical heaters

(76) Inventor: Tilak V. Bommaraju, Grand Island, NY (US)

Correspondence Address: Howard M. Ellis;SIMPSON & SIMPSON, PLLC, 5555 Main Street, Williamsville, NY, 14221, US

(21) Appl. No.: 11/657,852

(22) Filed: Jan. 25, 2007

Related U.S. Application Data
(60) Provisional application No. 60/764,213, filed on Feb. 1, 2006.

(51) Int. Cl. A47J 36/30; C01D 1/02; C01F 5/00; C01F 7/00; C01G 9/00; H01M 6/00

(52) U.S. Cl. 99/483; 423/594.14; 423/594.2; 423/594.4; 423/594.6; 423/600; 423/635; 429/122

(57) ABSTRACT

Less hazardous methods for generating energy for heating water, medical supplies or comestible products using improved flameless chemical heaters/flameless ration heaters by novel chemical or electrochemical means, each capable of suppressing the generation of hydrogen gas. Remote unit self heating meals may be heated by forming a reaction mixture comprising magnesium or a magnesium-containing alloy, a hydrogen scavenger and water, and reacting the reaction mixture to generate sufficient energy for heating the water, or other comestible product while simultaneously suppressing the generation of hydrogen. Alternatively, a battery may be employed using Mg and MnO₂.

### CROSS REFERENCE TO RELATED APPLICATION

This application claims the benefit of provisional application 60/764,213, filed Feb. 1, 2006.

### BACKGROUND OF THE INVENTION

Flameless Chemical Heaters (FCH), also known as Flameless Ration Heaters (FRH), are used in Meal, Ready-to-Eat (MRE) packaging to provide hot meals to military troops in the field or for warming or heating medical supplies or food rations in confined spaces (e.g., tents, underwater shelters) or in remote locations where there is no heat source. These FCHs or FRHs are generally based on the reaction of magnesium with water to form magnesium hydroxide and hydrogen which releases 85 kcal of energy per mole of magnesium.

There are two types of MREs. The first is an individual meal for the soldier. The second one is a Afamily-style≅meal for a group of 10-20 troops, called the Remote Unit Self Heating Meal (RUSHM). Both of these MREs use a Flameless Ration Heater (FRH) as the heat source for the hot meal. The temperature of an 8-ounce individual MIRE can be raised by 100° F. in about 10 minutes using a 0.5-ounce FRH. The process of heating the food consists of adding 1-2 fluid ounces of water to the FRH by the soldier, in order to activate the chemical reaction that produces the heat. Presently, the FRH consists of a magnesium, iron and salt mixture. The iron is used to activate the reaction, whereas the salt prevents the formation of a Magnesium oxide film on the magnesium metal surface. The reaction products are magnesium hydroxide and hydrogen. With the individual MRE, the liberation of up to 8 liters of hydrogen gas has not been a safety problem.

The Remote Unit Self Heating Meal or RUSHM is a complete meal in a box and can feed small groups of soldiers. Again, the food is heated by using a proportionally larger FRH that is activated by the addition or redistribution of water. The problem associated with the release of hydrogen is significantly magnified with group meals. The RUSHM weighs 26 pounds and requires approximately 20 ounces of heater material. The amount of hydrogen released is typically 11.3 cubic feet or 320 liters. Thus, the concern is that the generation of this large quantity of hydrogen in a confined space will exceed the Lower Explosive Limit of 4%.

Accordingly, there is a need for an improved system for the elimination, or at least reduction of hydrogen in flameless heaters.

### SUMMARY OF THE INVENTION

The objects of the invention are essentially two-fold. The first involves eliminating the generation of hydrogen in all types of MREs, thereby preventing the release of hydrogen into the atmosphere and also preventing potentially explosive situations by using a novel additive to the conventional FRH composition. The second addresses an innovative approach to realize electrical and thermal energy using a Mg—MnO₂ battery system. In this scheme, hydrogen generation is avoided by the appropriate selection of cathodic reactions; the heat generated being still the same as the FRH, since the anodic reaction is the reaction of Mg with water to form Mg(OH)₂.
Mg+2H₂O→Mg(OH)₂+H₂

This inventor found this novel Abattery≅will not only produce heat for the meals, but will also provide DC power. The amount of power generated can be as high as 1-1.5 KWH when the Mg—MnO₂ battery system is adapted. The system, configured in a flat plate mode, can easily be integrated in the RUSHM package without any major modification to generate electricity and heat for warming the MREs. Every soldier has hot meals once or twice a day and the power generated each time could be made available for whatever use the military sees as fit.

### BRIEF DESCRIPTION OF THE DRAWING

FIG. 1 is a discharge curve of the Mg—MnO₂ battery of the invention.

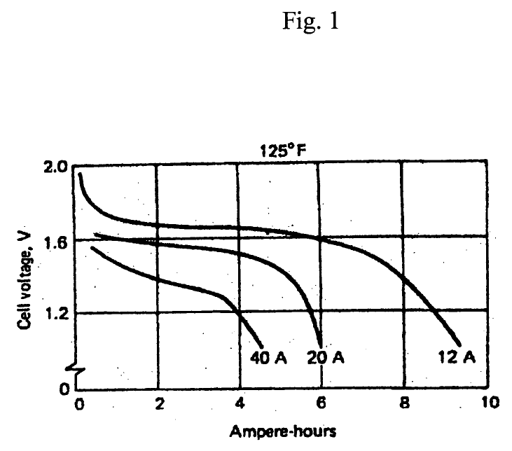

### DETAILED DESCRIPTION OF THE PREFERRED EMBODIMENTS

Hydrogen Suppression in MREs

This invention relates to a novel additive to magnesium to eliminate hydrogen generation, following the reaction scheme:
Mg°+2MnO₂+H₂O→Mn₂O₃+Mg(OH)₂

This reaction does not result in hydrogen generation, and yet it provides more heat than the Mg+H₂O reaction with water that is currently used in flameless chemical heaters or flameless ration heaters. It may be noted that addition of CuCl₂, NaNO₃, and trichloroacetic acid to magnesium was believed to eliminate the hydrogen evolution reaction. However, NaNO₃ and trichloroacetic acid are not effective in totally suppressing hydrogen generation, and CuCl₂ in the MREs is not acceptable because of environmental considerations.

The novel chemical composition that generates heat for heating water or medical supplies or consumable rations, without simultaneously generating hydrogen, contains a metallic element, hydrogen scavenger, hydrogen overvoltage suppressor, promoter, flowing agent, activator and water. Water acts as a reactant and a medium for the reaction. The metallic element in the chemical composition that generates heat is magnesium or magnesium alloy containing from about 0.001% to about 10% Fe, Co, Ni, Zn, Al, either singly or in combination with each other. The preferred composition is pure magnesium with <0.001% to about 0.1% of the alloying elements, Fe, Co, Ni, Zn and Al. The hydrogen scavenger in the chemical composition is MnO₂ and RuO₂. The preferred hydrogen scavenger is either γ-MnO₂ or β-MnO₂ made either electrolytically or chemically or from a naturally occurring ore that is treated. The amount of MnO₂ in the chemical composition is in the range of 1 to 10 times the stoichiometric amount required for the Mg+MnO₂ reaction with water, the preferred amount being 1-1.2 times the stoichiometry. The hydrogen overvoltage suppressor in the chemical composition is either a metal sulfide, the metal being Fe, Co, Ni, or carbon, or an organic species, present in amounts ranging from about 0.001 to about 1%. The promoter in the chemical composition is carbon in a powder form, in an amount from about 0.001% to about 10%. The activator for the reaction with this composition is NaCl, MgCl₂, MgBr₂, Mg(ClO₄)₂. The amount of activator can vary in the range from about 0.001 to about 50%. The preferred activator is NaCl.

Heat and Electricity Generation

This invention also provides sufficient energy to heat the MRE's without generating hydrogen and electricity. Thus, instead of using the magnesium plus iron based FRH, I propose using magnesium, or an alloy of magnesium based composition and MnO₂ layers separated by a spacer. Use of this system will suppress the generation of hydrogen and generate power. The overall reaction in this scheme is:
Mg°+2MnO₂+H₂O→Mn₂O₃+Mg(OH)₂
The component reactions constituting this overall reaction are as follows.
Mg→Mg²⁺+2e⁻
2MnO₂+H₂O+2e⁻→Mn₂O₃+2OH⁻

This is the principle of the Mg—MnO₂ battery systems. These batteries have excellent shelf lives and generate considerable heat (about 82 kcal/mole Mg), which is the same as that generated by Mg in the FRH, particularly at high discharge rates. These batteries also permit their usage as a FRH without hydrogen generation. This would provide heat via the reaction of the Mg+H₂O reaction, and the power, which can be used to charge the batteries in the field or generate heat. The electrodes will be designed in a flat-plate type configuration and inserted in the heater pouch of the RUSHM package. The leads from the anode and the cathode will be extended to the outside of the RUSH box, where the power becomes accessible when water containing metal salts is added to the heater pouch.

For the water activated Mg/MnO₂ battery, the MnO₂ electrode can be constructed by mixing electrolytic MnO₂ powder (Kerr-McGee Corporation) with a 5% Teflon® binder. A glass fiber filter paper can be used as a separator for initial experiments. Magnesium in the form a sheet can be used in the initially; subsequent experiments may be conducted with Mg granules (obtained from a commercial source) compacted into a pellet form. To make electrodes out of Mg granules, the granules will be mixed with Teflon T-30 (about 5 wt %) and pressed onto either Mg or Ni expanded metal. Activation can be done by both electrolyte incorporation and water addition. For water activation, the electrolyte salt will have to be incorporated in the electrode and/or the separator material.

I claim:

1. A method for generating energy for heating water, medical supplies or a comestible substance with the suppression of hydrogen generation, which comprises the steps of:
(i) forming a reaction mixture comprising magnesium or a magnesium-containing alloy, a hydrogen scavenger and water, and
(ii) reacting the reaction mixture of (i) to generate sufficient energy for heating the water, said medical supplies and the comestible substance while simultaneously suppressing the generation of hydrogen.

2. The method according to claim 1, wherein the hydrogen scavenger is a composition comprising manganese dioxide and ruthenium dioxide.

3. The method according to claim 1, wherein the magnesium-containing alloy comprises at least one alloying element selected from the group consisting of Fe, Co, Ni, Zn and Al.

4. The method according to claim 1, wherein the reaction mixture further comprises a hydrogen overvoltage suppressor, a promoter, a flowing agent and an activator.

5. A battery for generating a DC power supply and energy for heating water, medical supplies or a comestible substance, all without the generation of hydrogen, which comprises the reactions:
Mg→Mg²⁺+2e⁻
2MnO₂+H₂O+2e⁻→Mn₂O₃+2OH⁻

6. A heater pouch comprising the battery of claim 5, said battery comprising electrodes having a flat-plate type configuration disposed in a remote unit self heating meal pouch.
